(19) United States
(12) Patent Application Publication
(10) Pub. No.: US 2012/0327827 A1
(43) Pub. Date: Dec. 27, 2012

(54) Media Gateway

(75) Inventors: Dietmar Fiedler, Espoo (FI); Arturo Martin de Nicolas, Aachen (DE)

(73) Assignee: TELEFONAKTIEBOLAGET L M ERICSSON (PUBL), Stockholm (SE)

(21) Appl. No.: 13/520,453

(22) PCT Filed: Jan. 4, 2010
(86) PCT No.: PCT/EP10/50017

§ 371 Date: Sep. 5, 2012

(51) Int. Cl. H04B 7/24

(52) U.S. Cl. 370/310

(57) ABSTRACT

The present invention relates to a media gateway for managing a transmission of data from a first communication entity towards a second communication entity. The media gateway comprises a receiver (101) for receiving a first language indicator indicating a language associated with the first communication entity, and a processor (103) for determining upon the basis of the first language indicator and a second language indicator whether to translate the data into the language indicated by the second language indicator, the second language indicator indicating a language associated with the second communication entity.

### TECHNICAL FIELD

The present invention relates to the field of mobile communications.

In order to support a transmission of different services such as audio data or video data towards different recipients residing in e.g. different countries, efficient communication networks are necessary. An efficient horizontally layered architecture is e.g. described in “Control Servers in the Core Network”, Ericsson Review No. 4, 2000. By way of example, the layered network architecture as e.g. introduced with release for of the 3GPP (3rd Generation Partnership Project) specification comprises three distinct layers: an application layer, a network layer and a connectivity layer. The application layer supports end-user applications and may be implemented in mobile stations or application servers in the network. The application layer may interface with the network layer via a set of application program interfaces (API) which enables designing and implementing different services and applications. The network control layer supports communicating services across e.g. different types of networks such as circuit-switched domain networks based on the GSM standard using e.g. ISDN-related technology or packet-switched networks employing e.g. the GPRS technology. The connectivity layer is a transport layer capable of transporting any type of service via e.g. voice, data and multimedia streams.

For managing communications, the control layer may comprise, according to the UMTS (Universal Mobile Telecommunications System) technology, a mobile switching center (MSC) handling control layer functions at a border between an access network and a core network. The communication between the access network and the MSC server may be performed upon the basis of RANAP messages (Radio Access Network Application Protocol) which are usually transmitted by mobile stations. The network control layer according to the UMTS (Universal Mobile Telecommunications System) technology may further comprise a transit switching center (TSC) managing communications between the core network and another network such as e.g. ISDN (Integrated Services Digital

Network) or PSTN (Public Switched Telephone Network) network. The MSC and the TSC may communicate via gateway control protocol (GCP) messages with a respective media gateway (MGW) or mobile MGW (M-MGW) arranged in the connectivity layer for managing data transmissions. Typically, a MGW receives data from a communication entity, such as a mobile station or an application server, via the access network and e.g. converts the ATM (Asynchronous Transfer Mode) data streams into IP (Internet Protocol) data streams for further transport.

Another emerging communication technology for delivering multimedia services across fixed and mobile access networks is provided by the IP Multimedia

Subsystem (IMS) technology. The network architecture according to IMS comprises a service layer corresponding to the aforementioned application layer, a control and connectivity layer corresponding to the aforementioned network control layer and an access layer corresponding to the aforementioned connectivity layer. In particular, the control and connectivity layer may comprise call session control functions (CSCF) forming central nodes for the provision of the SIP signaling (SIP: Session Initiation Protocol). The control and connectivity layer further comprises a MGCF (Media Gateway Control Function) communicating with the CSCF via SIP messages and with media gateways arranged within the access layer using media gateway messages according to e.g. the H.248 protocol. The control and connectivity layer may further comprise a MRF (Media Resource Function) providing media services e.g. in a home network.

As the multimedia services which may be delivered to different fixed or mobile communication networks may comprise data in different languages, a question may arise as to which entity shall translate the data into a language which is accepted by a receiving communication entity such as a mobile or stationary user entity. Accordingly, there exists a need for efficiently managing communications of data with different languages.

### SUMMARY OF THE INVENTION

The invention is based on the finding that an efficient concept for managing communications of data in different languages may be based upon distributing language indicators indicating languages associated with communication entities such as mobile stations in communication networks. By way of example, a language indicator may be derived by the mobile station upon the basis of pre-stored language settings. Moreover, language indicators associated with communication entities may be stored in the HLRs or HSSs (Home Subscriber Server) for further distribution towards the communication networks. The language indicator may e.g. be formed by a number or by a certain code which may be unique for the respective language. Moreover, the language indicator may also indicate group of languages such as German or English which are associated with the respective communication entity.

According to an aspect, the invention relates to a media gateway for managing a transmission of data from a first communication entity towards a second communication entity over e.g. one or more communication networks. The media gateway may comprise a receiver for receiving a first language indicator indicating a language associated with the first communication entity, and a processor for determining upon the basis of the first language indicator and a second language indicator whether to translate the data into the language indicated by the second language indicator, wherein the second language indicator indicates a language associated with the second communication entity. The communication entities may be mobile stations or stationary stations communicating via access and/or core networks with each other in particular in a layered communication network scenario.

By way of example, the first language indicator may be transmitted towards the media gateway by the first communication entity or by a mobile switching center (MSC) communicating with the media gateway via gateway control protocol (GCP) messages. The second language indicator may be stored in the media gateway or transmitted towards the media gateway by the second communication entity or by e.g. a MSC or by a transit switching center (TSC) communicating with the media gateway, or even by a HLR. If the HLR does not have a connection towards the MGW, e.g. M-MGW, than the MSC may receive e.g. a default language indicator from the HLR e.g. in a Location Update message. The MSC may also apply this language indicator if it is not provided by a communication entity such as a mobile station.

According to an embodiment, the processor may be configured to determine to translate the data into the language which is indicated by the second language indicator if the first language indicator differs from the second language indicator. The term “differs” may denote a partial or a total difference between the language indicators.

According to an embodiment, the media gateway may comprise a forwarder for forwarding the data towards a language translation entity for translating the data into the language indicated by the second language indicator to obtain translated data if the language indicated by the first language indicator differs from the language indicated by the second language indicator. The forwarder may e.g. be formed by the MRFC according to the IMS technology. However, the forwarder may be any transmitter which is capable of transmitting data towards the language translation entity. The data transmission towards the language translation entity which may be arranged in a remote communication network may be based upon a roaming agreement translation service between e.g. different network operators sharing translation resources. The media gateway may be accessible via a communication network so that the forwarder may forward the data for translation towards the translation entity over the communication network.

According to an embodiment, the media gateway may comprise a language translation entity being configured to translate the data into the language indicated by the second language indicator. The language translation entity may have features corresponding to those described with reference to the above mentioned language translation entity.

According to an embodiment, the receiver may be configured to receive a gateway protocol message comprising the first language indicator, wherein the processor may be configured to extract the first language indicator from the gateway control message. The gateway control message may correspond to a message according to the H.248 protocol or to the GCP protocol or to any other gateway protocol.

According to an embodiment, the media gateway may comprise a forwarder, e.g. a transmitter, which is configured to pass the data towards the second network entity if the language indicated by the first language indicator corresponds to the language indicated by the second indicator, e.g. when the language indicators at least partly correspond to each other. In order to pass the data, the forwarder may simply relay the data towards the second network entity. Alternatively, the forwarder may be configured to transmit translated data towards the second network entity, the translated data representing a translation of the first data into the language indicated by the second quality indicator. The translation may be performed by one of the above mentioned translation entities.

According to an embodiment, the media gateway may be configured to communicate with a network control entity such as MSC or TSC for receiving the first or the second language indicator. The communication with the respective network control entity may be performed upon the basis of the H.248 protocol or the GCP protocol.

According to a further aspect, the invention relates to a network control entity, e.g. a RSC or TSC or MRF, for controlling communications of a communication entity. Preferably, the network control entity comprises a receiver for receiving a signaling message from the communication entity, a processor for detecting a language indicator in the signaling message, the language indicator indicating a language associated with the communication entity, and a forwarder, e.g. a transmitter, for forwarding the language indicator towards another network entity. The signaling message may be e.g. a RANAP message or a 2G signaling message, by way of example.

According to an embodiment, the processor may be configured to extract the language indicator from the signaling message if the signaling message comprises the language indicator. By way of example, the processor may analyze the received signaling message in order to determine whether the same comprises any language indicator which may be arranged e.g. in an address field or any other field of the signaling message.

According to an embodiment, the forwarder may be configured to transmit a language indicator request towards a home location register (HLR) in order to request the language indicator if the signaling message does not comprise the language indicator. In response thereto, the HLR may transmit the requested language indicator towards the network control entity, which may comprise a receiver for receiving the language indicator from the HLR.

According to an embodiment, the signaling message may be a Location Update message from a Home Location Register.

According to an embodiment, the processor may be configured to insert the language indicator into an address message, e.g. into the initial address message (IAM), wherein the forwarder may be configured to transmit the resulting address message towards the other network control entity, in particular towards a TSC or a MSC. The processor may further be configured to insert the language indicator into a gateway control protocol message, wherein the forwarder may be configured to transmit the resulting gateway control protocol message towards the other network control entity, in particular towards a media gateway.

According to an embodiment, the network control entity may be a MSC, wherein the signaling message may be a RANAP message provided by e.g. a mobile station.

According to an embodiment, the network control entity may be a TSC which may be configured to communicate with another network entity, in particular with a MSC, wherein the receiver may be configured to receive the signaling message from the other network entity, wherein the processor may be configured to extract the language indicator from the signaling message, and wherein the forwarder may be configured to transmit the language indicator towards a media gateway, e.g. towards the media gateway mentioned above.

According to some implementations, the features of the aforementioned forwarders may be embodied in one forwarder. However, particular features of the aforementioned forwarders may be embodied in distinct forwarders forming further embodiments of the invention.

According to an aspect, the invention relates to a mobile station comprising a processor which may be configured to insert a language indicator indicating a language associated with the mobile station into a signaling message. The signaling message may be e.g. the RANAP message or the SIP message. The mobile station may further comprise a transmitter for transmitting the signaling message towards a MSC to set up a communication link. Furthermore, the mobile station may form an embodiment of one of the communication entities mentioned above.

According to an aspect, the invention relates to a multimedia resource function entity according to the IMS technology, comprising a receiver for receiving data for translation, and for receiving a language indicator indicating the language into which to translate the data. The language indicator and the data for translation may be received via different communication channels, e.g. via a control channel and a data channel. The multimedia resource function entity may further comprise a translator for translating the data into the language indicated by the language indicator to obtain translated data and a transmitter for transmitting the translated data towards a communication network. The translator may e.g. operate according to any translation algorithm in order to translate the data into the required language.

According to an aspect, the invention relates to a method for managing a transmission of data from a first communication entity towards a second communication entity. The method comprises receiving a first language indicator indicating a language associated with the first communication entity, and determining upon the basis of the first language indicator and a second language indicator whether to translate the data into the language indicated by the second language indicator, the second language indicator indicating a language associated with the second communication entity. Further method steps are directly derivable from the functionality of the inventive media gateway.

According to an aspect, the invention relates to a method for controlling communications of a communication entity, the method comprising receiving a signaling message from the communication entity, detecting a language indicator in the signaling message, the language indicator indicating a language associated with the communication entity, and forwarding the language indicator towards a network control entity.

Further method steps are directly derivable from the functionality of the network control entity.

According to an aspect, the invention relates to a computer program for performing one of the above mentioned methods when run on a computer.

According to an aspect, the invention relates to a programmably arranged network entity being configured to execute the above mentioned computer program to perform one of the above mentioned methods. The programmably arranged network entity may be a media gateway or a MSC or a TSC or a MRF, by way of example.

### BRIEF DESCRIPTION OF THE DRAWINGS

Further embodiments of the invention will be described with reference to the following figures, in which:

FIG. 1 shows a media gateway for managing communications between a first and a second communication entity according to an embodiment;

FIG. 2 shows a network control entity for controlling communications of a communication entity according to an embodiment;

FIG. 3 shows an embodiment of a mobile station according to an embodiment;

FIG. 4 shows an embodiment of a multimedia resource function entity (MRF) according to an embodiment;

FIG. 5 shows a layered network scenario according to an embodiment;

FIG. 6 shows embodiments of interfaces;

FIG. 7 shows a layered communication scenario according to an embodiment;

FIG. 8 shows an embodiment of a mobile originating call;

FIG. 9 shows signaling messages transmitted according to an embodiment;

FIG. 10 shows an embodiment of a mobile originating call;

FIG. 11 shows signaling messages according to an embodiment;

FIG. 12 shows an embodiment of a mobile originating call;

FIG. 13 shows embodiments of signaling messages;

FIG. 14 shows embodiments of signaling messages;

FIG. 15 shows embodiments of signaling messages;

FIG. 16 shows embodiments of signaling messages;

FIG. 17 shows an embodiment of a mobile originating call;

FIG. 18 shows a layered communication network scenario according to an embodiment;

FIG. 19 shows a layered communication scenario according to an embodiment;

FIG. 20 shows an embodiment of signaling messages; and

FIG. 21 shows an embodiment of a translation process.

### DETAILED DESCRIPTION

Before embodiments of the invention are described in detail, it is to be understood that this invention is not limited to the particular component parts of the devices described or steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise.

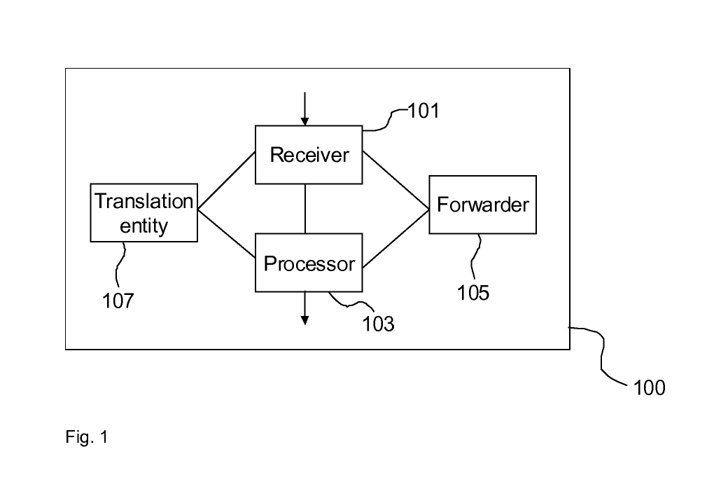

FIG. 1 shows a media gateway (MGW) 100 for managing communications between a first and a second communication entity according to e.g. a layered network scenario. The MGW may comprise a receiver 101 for receiving a first language indicator indicating a language, e.g. German or English, associated with the first communication entity, e.g. a mobile station, and a processor 103 for determining upon the basis of the first language indicator and a second language indicator which indicates the language associated with the second communication entity whether to translate the data into that language or not. The receiver 101 may further be configured to also receive the data for translation. The media gateway may optionally comprise a forwarder 105, e.g. a transmitter, for forwarding the data towards e.g. a remote language translation entity for translating the data. The forwarder 105 may communicate via a communication network with the remote translation entity according to any communication technology. However, the media gateway may comprise its own language translation entity 107 for translating the data into the language indicated by the second language indicator. The language translation entity 107 may be configured to execute any translation algorithm for translating the data into the respective language.

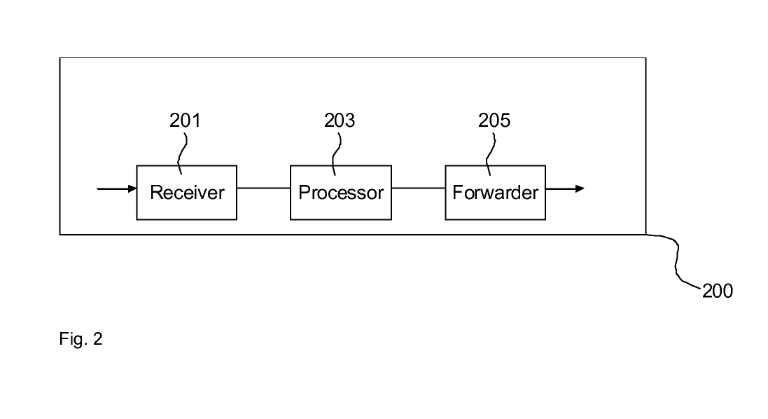

FIG. 2 depicts a network control entity 200 for controlling communications of a communication entity such as a mobile station, wherein the network control entity comprises a receiver 201 for receiving a signaling message from the communication entity. The network control entity may further comprise a processor 203 receiving the signaling message from the receiver 201 for determining and detecting the language indicator in the signaling message. The network control entity may further comprise a forwarder 205 for forwarding the language indicator towards another network control entity. The forwarder 205 may be formed by a transmitter for transmitting the language indicator within a transmission frame towards the other network control entity. The network control entity and the other network control entity may be respectively a MSC or TSC, by way of example.

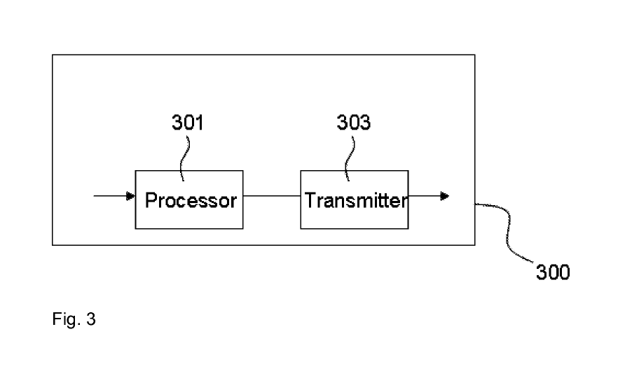

FIG. 3 shows an embodiment of a mobile station 300 comprising a processor 301 for inserting a language indicator indicating a language associated with the mobile station into a signaling message, which may be formed by a radio access network application part message. The mobile station may further comprise a transmitter 305 for transmitting the signaling message, e.g. an enhanced RANAP message, towards a mobile switching center to set up a communication link over e.g. a layered communication network.

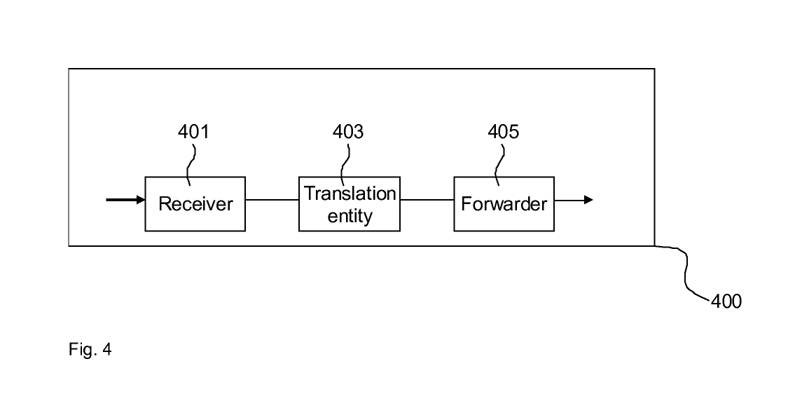

FIG. 4 depicts an embodiment of a multimedia resource function entity (MRF) 400 comprising a receiver 401 for receiving data for translation, wherein the receiver 401 may further receive a language indicator indicating the language into which to translate the received data. The MRF 400 may further comprise a translation entity 403 for translating the data into the language indicated by the received language indicator, and a transmitter 405 for transmitting the resulting translated data towards a e.g. layered communication network.

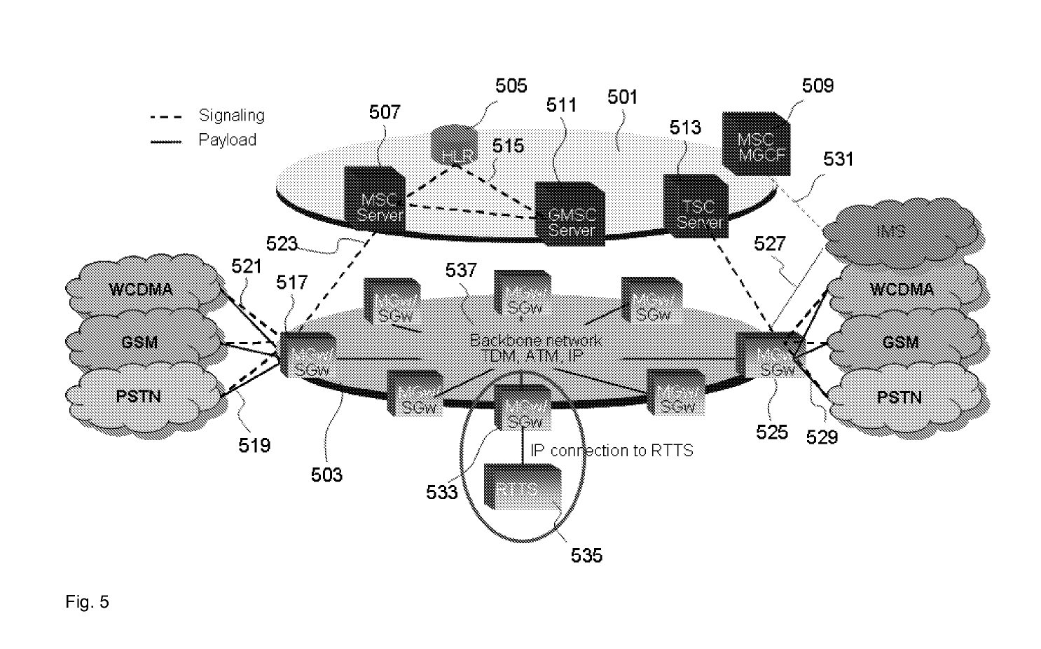

FIG. 5 depicts an architecture of a layered network, wherein, by way of example, a control layer 501 and a connectivity layer 503 are shown. The control layer may comprise a HLR 505, a first MSC 507, a second MSC (or MGCF) 509, a GMSC 511 and a TSC 513, by way of example. The HLR 505, the MSC 507 and the GMSC 511 may communicate over signaling paths 515 depicted by the dashed lines.

The connectivity layer 503 may comprise a plurality of MGWs or SGWs (Signaling

Gateway), wherein, in particular, a first MGW 517 is arranged on an edge of the connectivity layer 503 to exchange payload messages 519 depicted by the solid lines and signaling messages 521 depicted by the dashed lines with communication networks according to e.g. the WCDMA (Wideband Code Division Multiplex Access), GSM (Global System for Mobile Communications) or PSTN

(Public Switched Telephone Network) technology. The MGW (or SGW) 517 may communicate via a signaling path 523 with the MSC 507 in order to transmit signaling messages such as RANAP messages.

The connectivity layer 503 may comprise a further MGW (or SGW) 525 which may be arranged on the other edge of the connectivity layer 503 for communicating with communication networks according to the IMS, WCDMA, GSM or PSTN technology via e.g. payload paths 527 depicted by the solid lines and signaling paths 529 depicted by the dashed lines. The second MGW 525 may communicate with the TSC 513 of the control layer for receiving e.g. GCP messages. In addition, the second MSC 509 of the control layer 501 may communicate via a signaling path 531 with e.g. an IMS network.

By way of example, the connectivity layer 503 may comprise a third MGW (or SGW) 533 communicating with a translation entity 535 providing e.g. a real-time translation service (RTTS). The connection may be based upon the IP protocol in order to provide data for translation to the translation entity 535 and to receive translated data from the translation entity 535. By way of example, the translation entity 535 and the third MGW 533 may be arranged on the same network side to reduce network transmission delays. According to some implementations, the translation entity 535 may be also integrated in the third MGW 533 or in any MGW of the connectivity layer 503. The MGWs of the connectivity layer 503 may further communicate via a backbone network 537 according to e.g. the TDM (Time Division Multiplex), the ATM (Asynchronous Transfer Mode) or IP (Internet Protocol) technology.

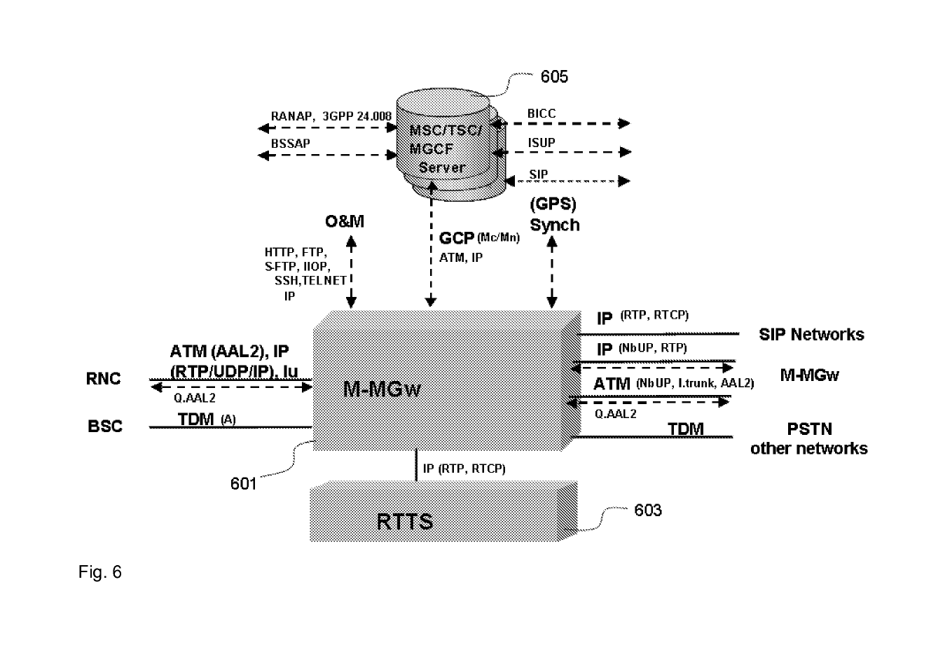

FIG. 6 depicts embodiments of interfaces of the MGW 601 interfacing with e.g. a translation entity 603 which may provide the RTTS via e.g. an IP interface. Furthermore, the MGW 601 may interface with a network entity 605, e.g. with a MSC or TSC or MGCF via the interface and interface technologies depicted in FIG. 6. By way of example, in order to distribute the language indicator, i.e. the language parameter, in particular signaling messages according to different protocols such as GCP or RANAP or BECC or ISUP or MSC-HLR interface, i.e. a D interface, adding a preferred language indicator to the subscriber data may be employed. Thus, by way of example, the originating MSC server 605 may receive the configured or preferred language restored in the HLR during e.g. a location update from the HLR. The originating MSC server 605 may store the preferred language indicator for the subscriber. Alternatively or additionally, the mobile station may inform the MSC 605 about the used language by e.g. transmitting the language indicator towards the MSC 605. In turn, the MSC 605 may inform the MGW 601 about the used language e.g. in the termination creation or termination modification, wherein the language indicator may be provided by the mobile station or by a base station system (BSS) or by the HLR. By way of example, if the language of two terminations, e.g. the language of two network entities communicating with each other, is different, then the MGW 601 may create a connection to the translation entity 603 and route the payload data via e.g. a RTTS server. Furthermore, an integrated translation entity using an integration translation algorithm may be employed.

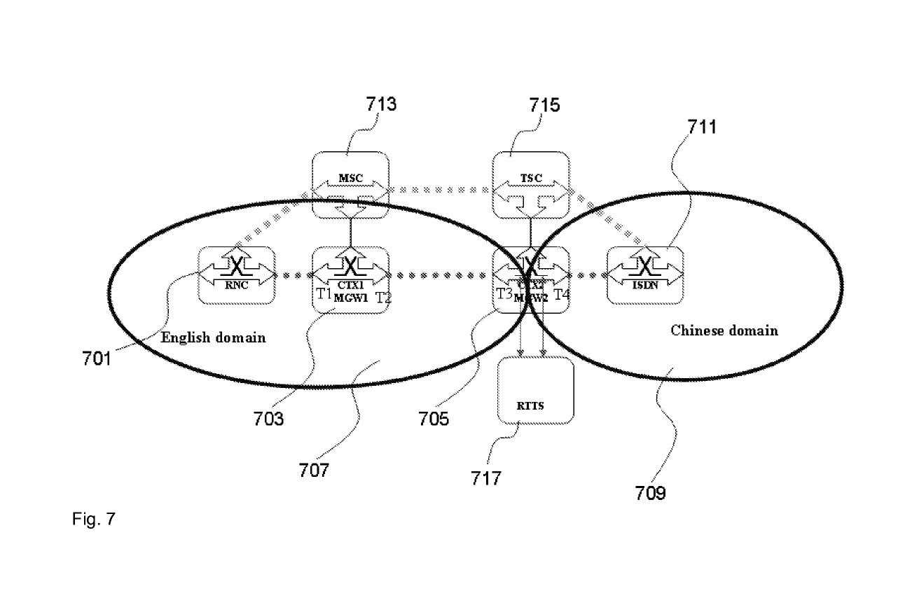

FIG. 7 shows a layered communication scenario comprising, in the connectivity layer, a radio network controller 701 (RNC) communicating data towards a first

MGW 703. The first MGW 703 forwards the data towards a second MGW 705.

The RNC 701 and the first MGW 703 may be arranged in an English domain 707, wherein the second MGW 705 may be arranged between the English domain 707 and a Chinese domain 709, by way of example. The second MGW 705 may forward data towards a communication entity 711, e.g. a ISDN entity, arranged in the Chinese domain 709.

In the control layer, a MSC 713 and a TSC 715 may be provided. The MSC 713 communicates with the RNC 701 and the MGW 703, wherein the TSC 715 communicates with the second MGW 705 and with the network entity 711. Furthermore, the second MGW 705 may be arranged to communicate with a translation entity 717, e.g. RTTS.

The RNC 701 may provide via a RANAP message a first language indicator, indicating e.g. the English language, towards the MSC 713 which, optionally, may forward the first language indicator towards the first MGW 703. Furthermore, the

MSC 713 may forward the first language indicator towards the TSC 715 which, in turn, forwards the received first language indicator towards the second MGW 705. Furthermore, the network entity 711 may transmit a second language indicator indicating e.g. the Chinese language towards the TSC 715 which, in turn, transmits the second language indicator towards the second MGW 705. The second MGW 705 decides, upon the basis of the first and the second language indicator, whether to translate the data T3 into the Chinese language to obtain translated data T4, or not to translate the data.

By way of example, the first MGW 703 may be adapted to handle data streams

T1, T2 and T3 according to the English language. In order to provide a Chinese translation of the data, the second MGW 705 may forward the data towards the translation entity 715 and receive translated data stream T4 in Chinese which may be provided to the network entity 711. By way of example, the data stream T3 at the input of the second MGW 705 may directly be provided to the translation entity 717 instead of being directly forwarded towards the output of the second MGW 705 to form the data stream T4. Thus, the input and the output of the second MGW 705 may directly be connected to the translation entity 717.

In the following, some implementations of a core network (CN) level call will be described according to which, by way of example, the language indicator is provided by a mobile station and by e.g. a PSTN network.

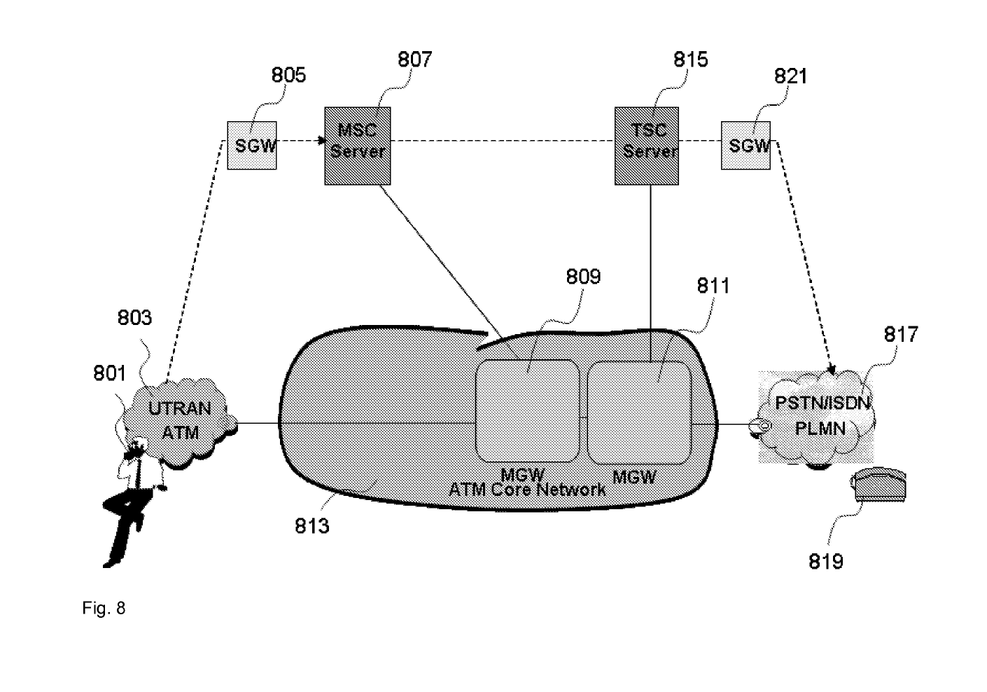

FIG. 8 shows an embodiment of a mobile originating call according to a layered network scenario. By way of example, a mobile station 801 may transmit a first language indicator via an access network 803, e.g. UTRAN ATM (UTRAN: UMTS

Terrestrial Radio Access Network), towards a SGW 805 (signaling gateway) communicating with a MSC 807. The MSC 807 forwards the first language indicator towards a first MGW 809 communicating with a second MGW 811 via e.g. an ATM core network 813. The MSC 807 may also retransmit the first language indicator towards a TSC 815 forwarding the first language indicator towards the second MGW 811. The second MGW 811 may communicate via a further access network 817, e.g. PSTN/ISDN or PLMN, with a second communication entity 819. The TSC server 815 may transmit a second language indicator towards the second MGW 811, the second language indicator indicating the language associated with the second communication entity 819. The language indicator may be provided to the TSC 815 by a further SGW 821 arranged between the further access network 817 and the TSC 815.

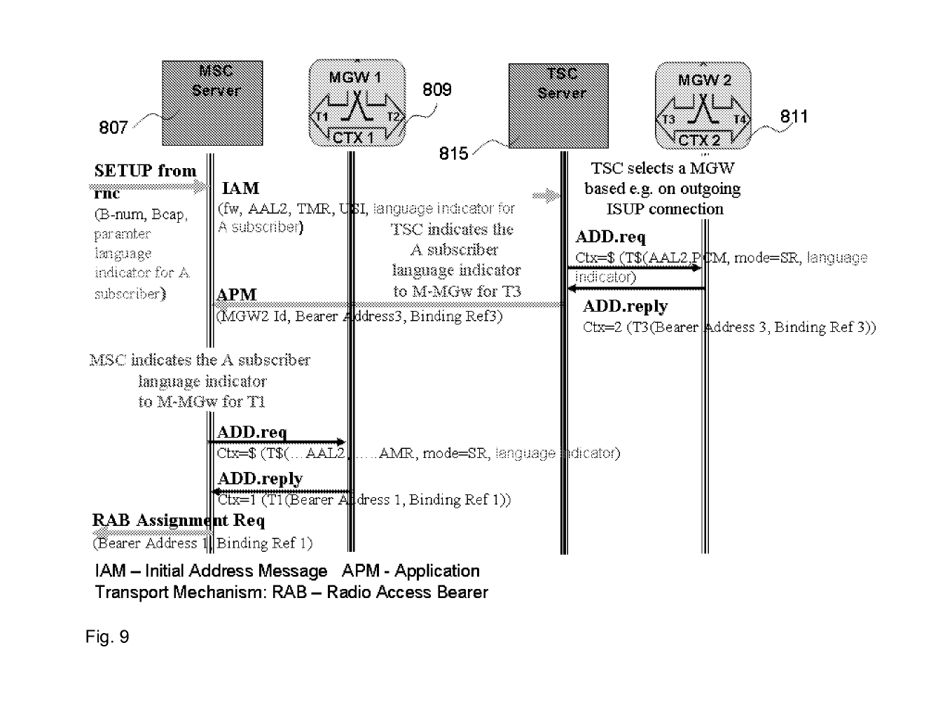

FIG. 9 depicts signaling messages transmitted according to the setup shown in FIG. 8, wherein the term “subscriber A” relates to the first communication entity 801. As shown in FIG. 9, the language indicator may be inserted into the IAM message and/or into the ADD.req message and/or into the initial setup message or into other messages according to e.g. the RANAP, the BICC or the ISUP protocol. By way of example, if a language indicator is not present in the setup message shown in FIG. 9, then the MSC 807 man retrieve the preferred language indicator from the stored subscriber data which may be received e.g. in a location update.

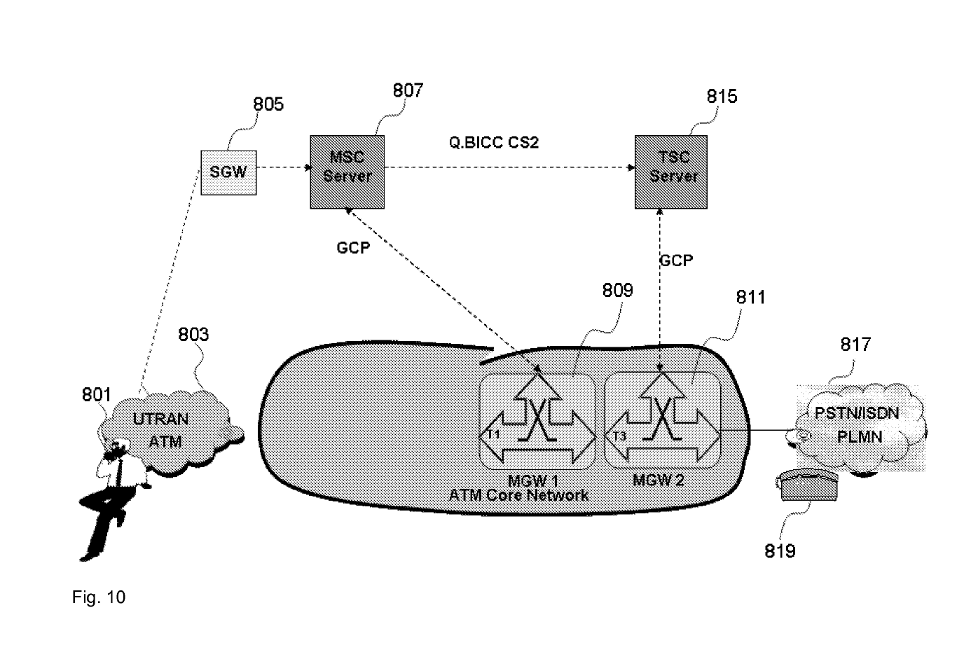

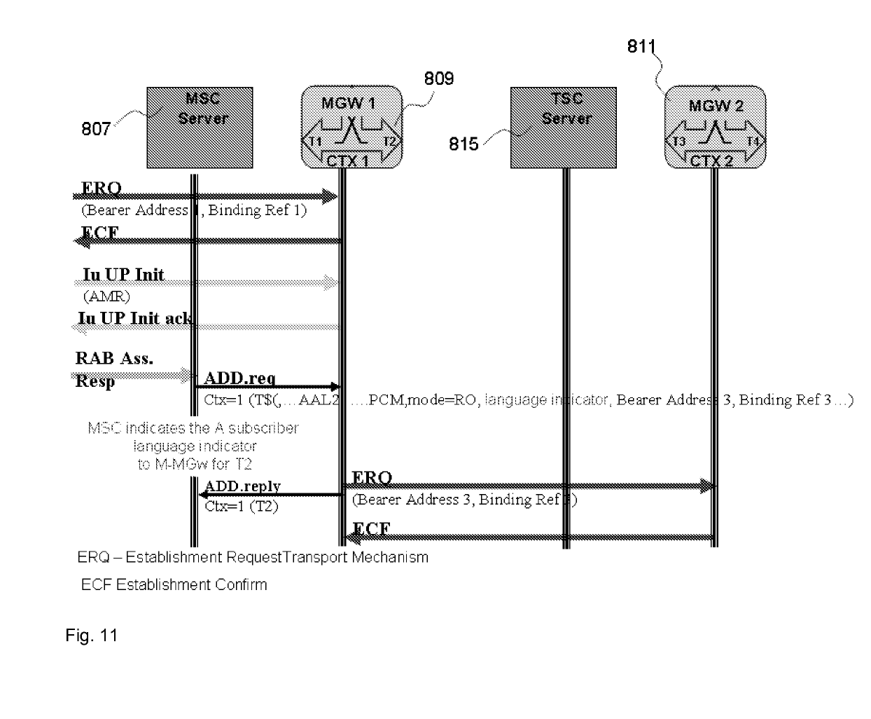

FIG. 10 shows an embodiment of a mobile originating call corresponding to the embodiment of FIG. 8, wherein the MSC 807 communicates with the TSC 815 via Q.BICC CS2 signaling messages. Furthermore, the MGWs 809 and 811 communicate with the MSC 807 and the TSC 815 upon the basis of the GCP messages. As depicted in FIG. 10, the language indicator may indicate that the data streams T1 and T3 are in English. The corresponding signaling messages are depicted in FIG. 11.

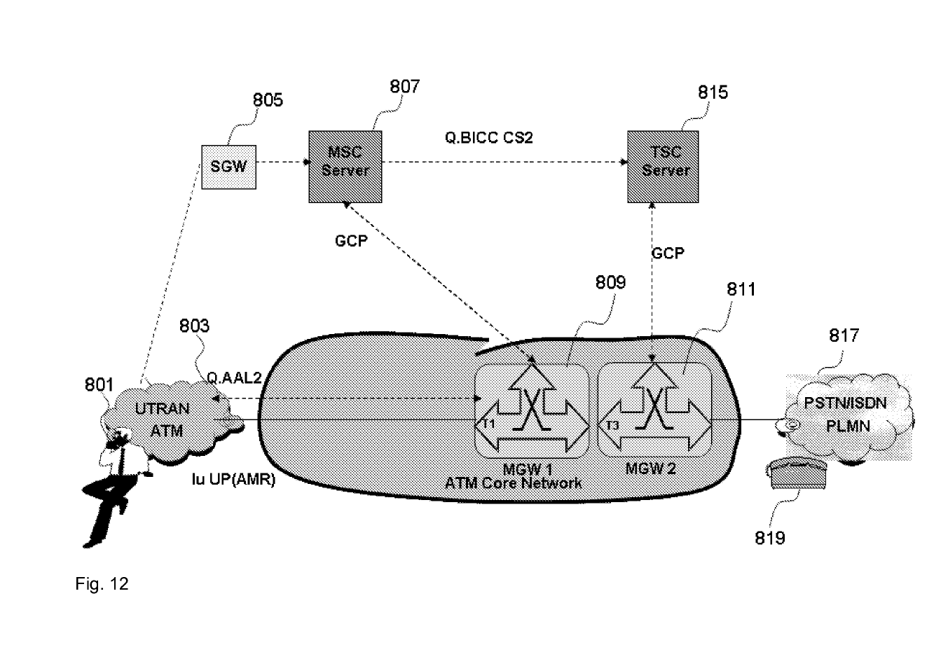

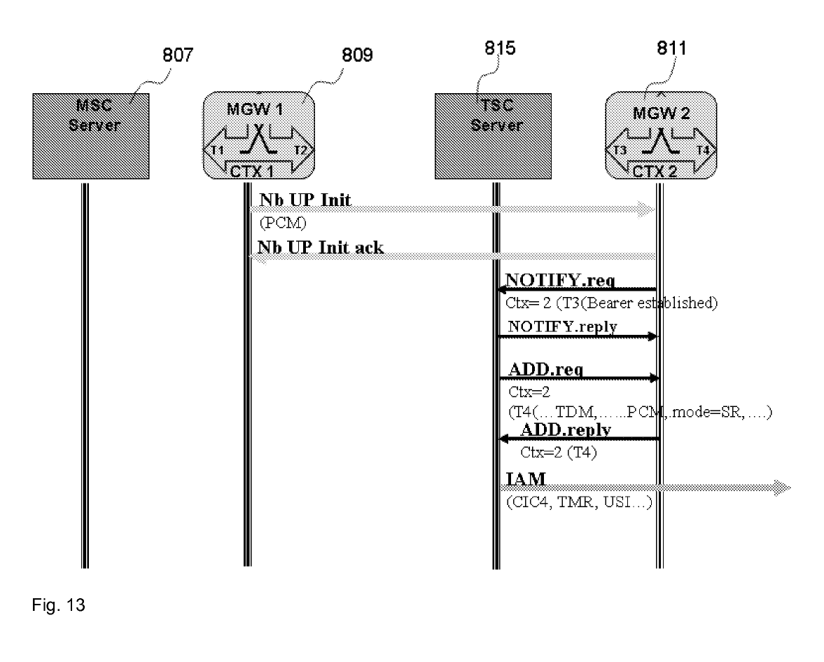

FIG. 12 shows an embodiment of a mobile originating call corresponding to the embodiment of FIG. 10, wherein the first MGW 809 exchanges further messages with the first access network 803 according to the Q.AAL2 and lu UP (AMR) protocols. By way of example, the language indicator may indicate that the data streams T1, T2 and T3 are in English. FIG. 13 shows embodiments of the resulting signaling messages. At this time, the TSC 815 may not know about the language indicator for the data T4. Thus, the MGW 811 may not receive the corresponding language indicator at this stage of proceedings.

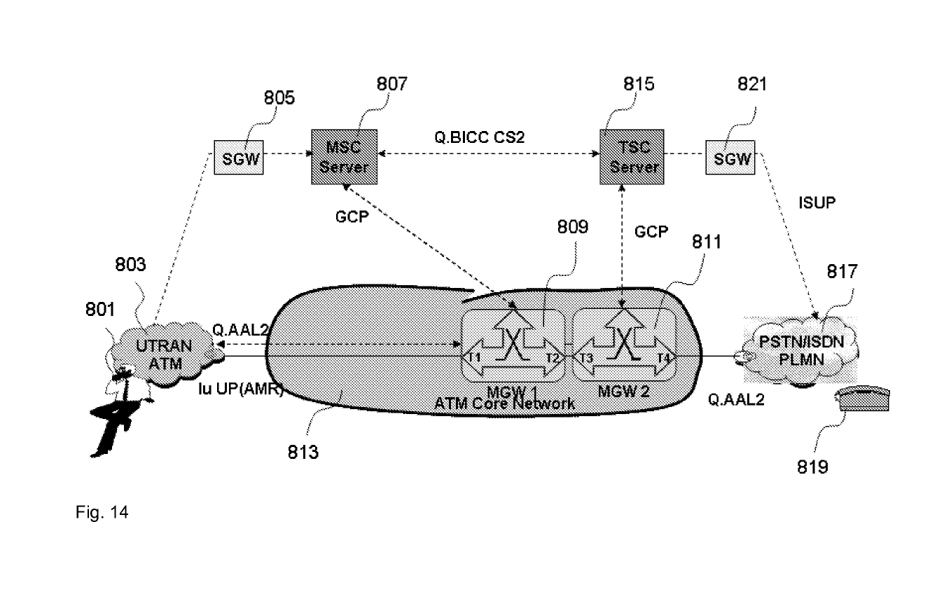

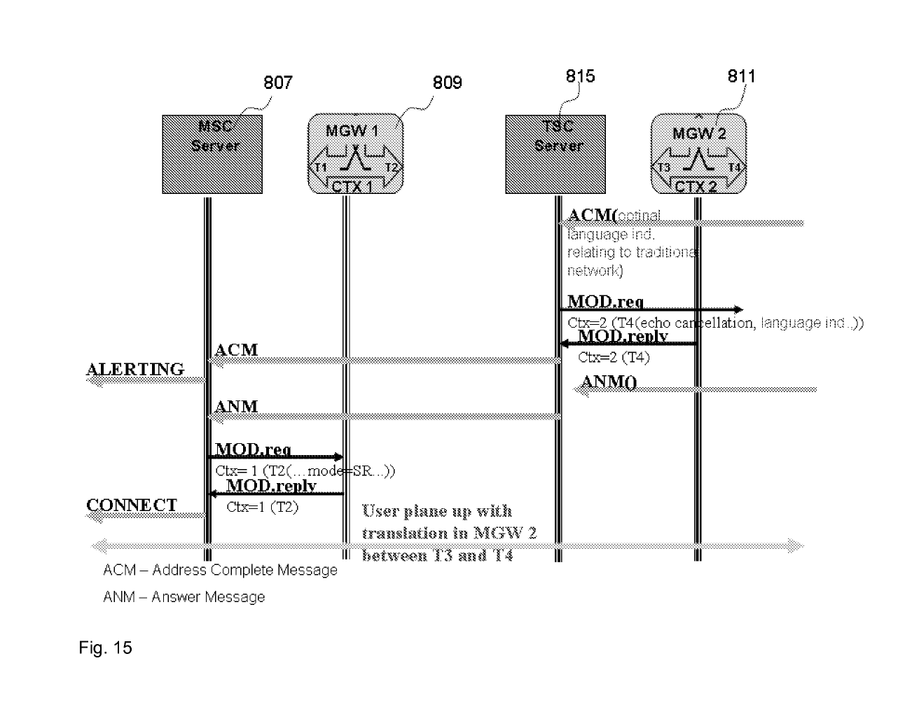

FIG. 14 depicts further messages which may be transmitted within the system as depicted in FIG. 8. By way of example, the language indicator may indicate that the data streams T1, T2 and T3 are in English wherein the required language of the data stream T4 may not be known at this point. FIG. 15 shows corresponding signaling messages, wherein the language indicator may be incorporated into the ACM message. By way of example, the M-MGW 811 may detect that the received language indicators for the data streams T3 and T4 do not match. Therefore, the

M-MGW 811 may invoke the translation algorithm. With regard to the ACM message or with regard to any messages or any data transmission or reception, an echo cancellation may optionally be performed.

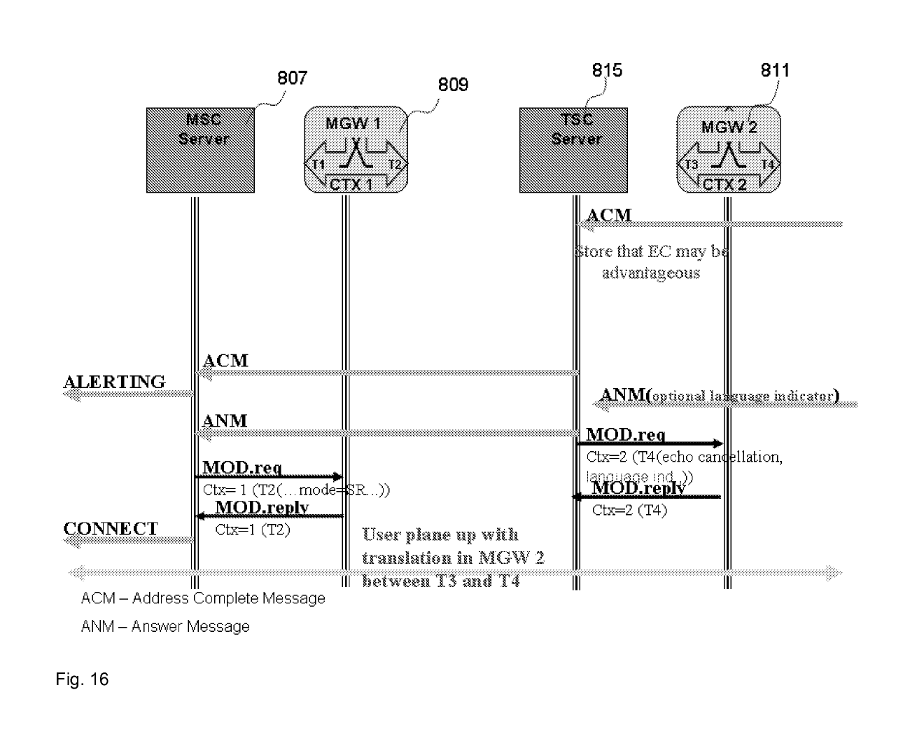

FIG. 16 shows further signaling messages, wherein the language indicator may optionally be inserted into the ACM message. By way of example, the M-MGW 811 may detect that the received language indicators for the data streams T3 and T4 do not match. Therefore, the M-MGW 811 may invoke the translation algorithm. If the language indicator is present in the ANM message provided to the TSC 815, then a MOD command with a stored EC and language indicator for B-Sub may me initiated.

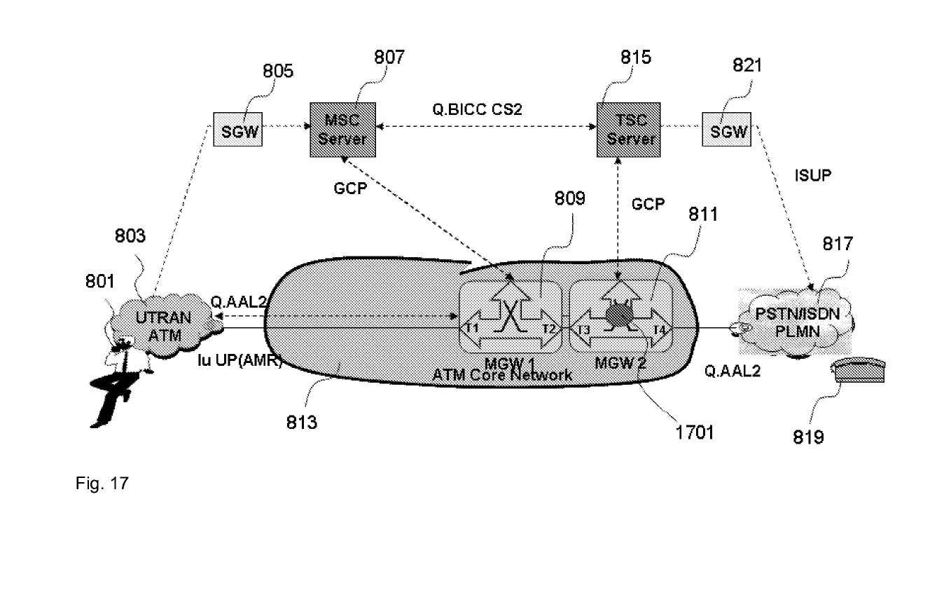

FIG. 17 depicts the system of FIG. 8, wherein the second MGW 811 may comprise a translation entity 1701 being configured to perform a translation algorithm between data streams T3 and T4 in order to translate data from English, data T1, T2 and T3, to Chinese, data T4.

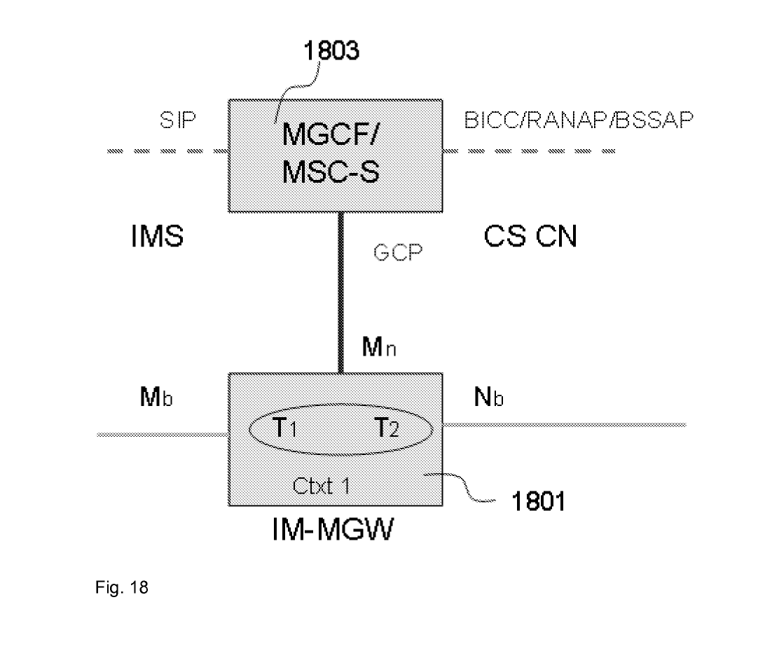

FIG. 18 shows a layered communication network according to the IMS technology comprising a MGW 1801 communicating with a MGCF/MSC 1803 via e.g. GCP signaling messages. The MGCF 1803 may be arranged to communicate according to the SIP or BICC or RANAP or BSSAP signaling approaches. As depicted in FIG.

18, the MGW 1801 may not comprise any translation entity for translating data T1 and T2. In this case, the MGW 1801 may transmit the data for translation to a remote translation entity which is not depicted in FIG. 18.

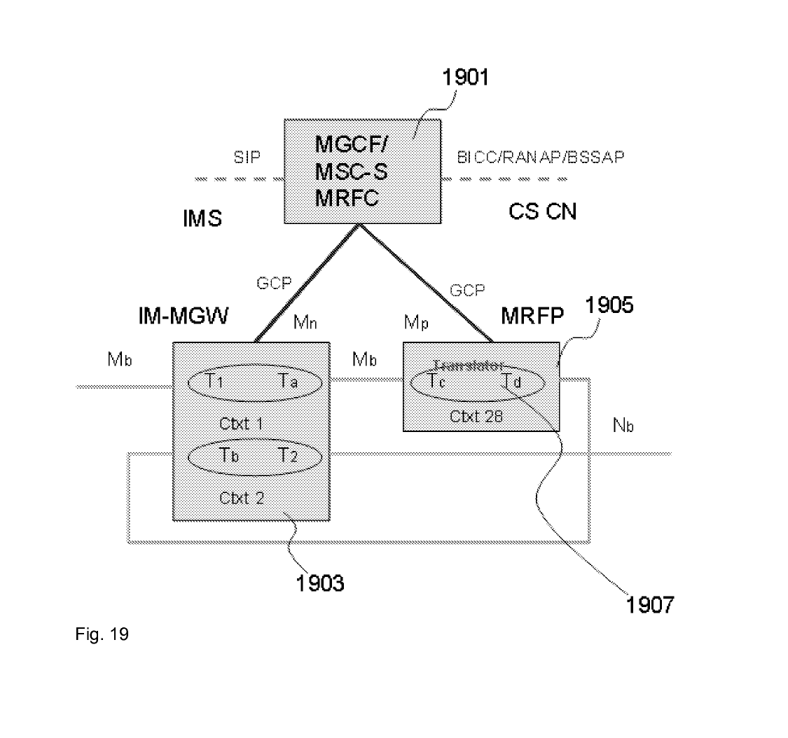

FIG. 19 shows a layered communication scenario according to the IMS technology comprising a MGCF/MSC/MRFC 1901 (MRFC: Multimedia Resource Function Controller) communicating with a MGW 1903 and a MRFP 1905. The MRFP 1905 (Multimedia Resource Function Processor) may comprise a translation entity 1907 for translating data.

In reference to FIG. 19, a Multimedia Resource Function (MRF) may be equipped with real-time translation services that can be linked into a call or session which may be required by end users or entities according to some implementations. The MRF may comprise the MRFC 1901 and the MRFP 1905. According to the embodiment of FIG. 19, a call is established between the Core Network Circuit-Switched (CNCS) domain and the IP Multimedia Services (IMS) domain.

After call establishment, one of the end-users may activate a translation service of the translation entity 1907. According to some implementation, this activation process may automatically be performed, based e.g. on subscriber data and on the deployment of the services.

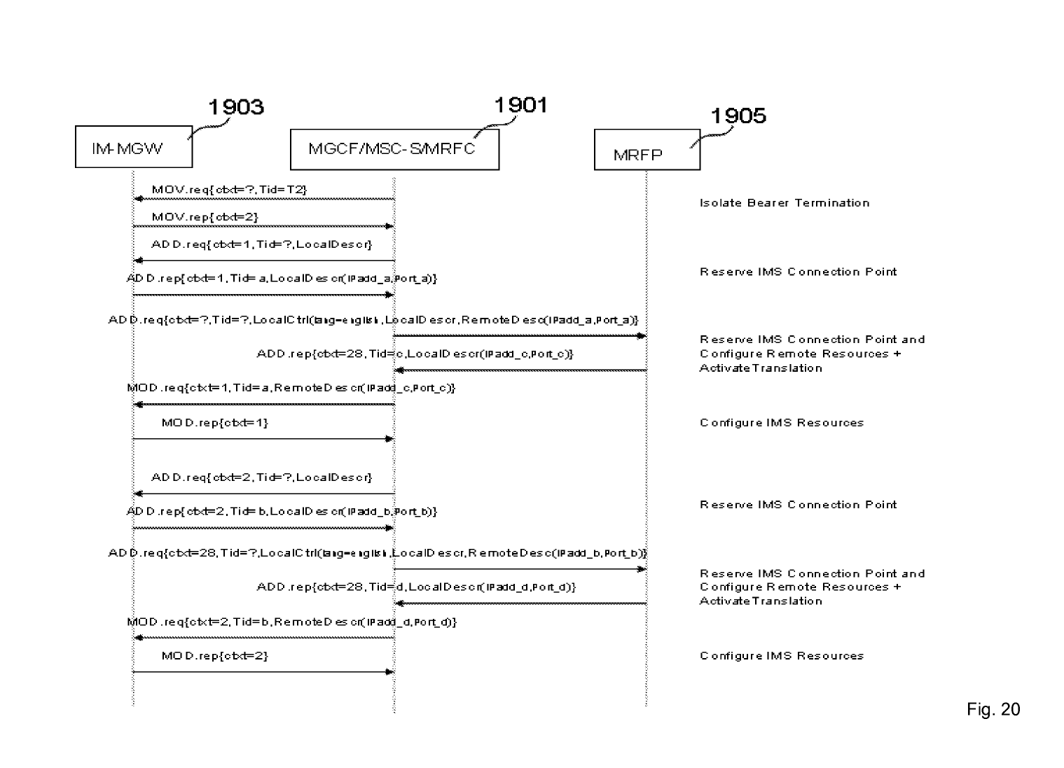

As shown in FIG. 19, the MGCF/MSC-S 1901 may also able to control the MRFP 1905. In this case, the MGCF/MSC-S 1901 may have the MRFC functionality. The MRF function is then triggered, which results in the connections as depicted in FIG. 20.

FIG. 20 depicts an embodiment of signaling messages resulting when employing the setups shown in FIGS. 18 and 19. As depicted in FIG. 20, the GCP signaling message is enhanced to comprise an “activate translation” instruction instructing the MRFP 1905 to translate data into the language indicated by language indicator provided e.g. via the GCP message.

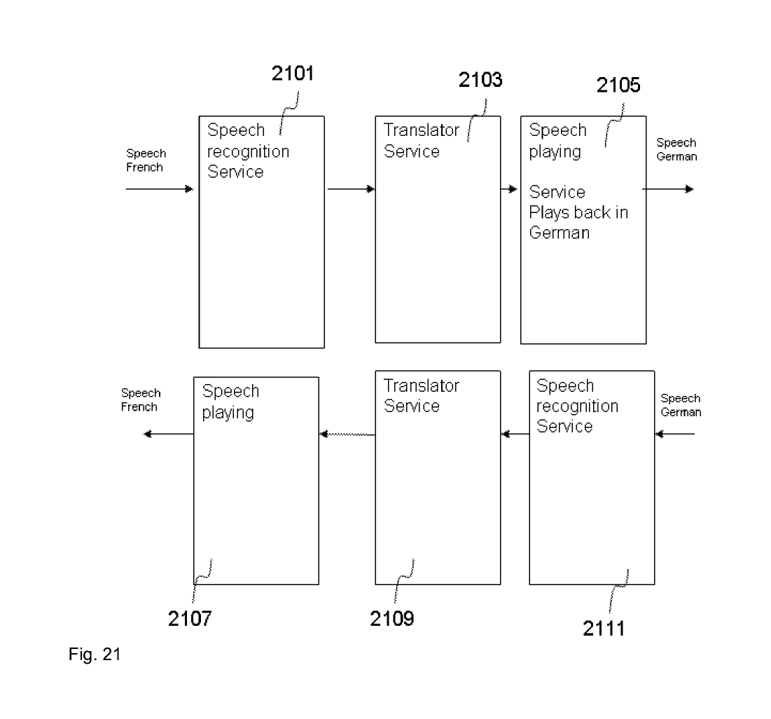

FIG. 21 shows an embodiment of a translation process employing a speech recognition service 2101 recognizing the speech (e.g. French) and e.g. recording it for a translator service 2103 for data translation e.g. into German, a speech playing service 2105 e.g. playing the data back in e.g. German, a speech recognition service 2111 recognizing the speech, e.g. German, and e.g. recording it for a further translator service 2109 translating the data e.g. into French, and a further speech playing service 2107 playing the data back in e.g. French.

With reference to FIG. 21, a translation service inside the networks may be established upon a basis of a translation media gateway which allows network operators to charge for the translation service.

By way of example, the translation service may be used for traditional calls between e.g. two participants, one of them speaking e.g. German, the other person speaking English. Thus, the translation media gateway may translate between these two languages.

Furthermore, conference calls with the translation function are also possible as well, wherein each participant may call in a different language, e.g. German, Italian and Spanish, and the system may translate between these languages.

According to some embodiments, the following services may be employed in the User Plane: speech recognition for all supported languages, which is optional if language indicators are distributed, translation function and speech generation function.

In the corresponding conference device, the speech may be translated to a common language, e.g. English, wherein every participant may have a speech recognition service for his language, and a translator from and into English. Thus, efficient phone calls between users speaking different languages as well as phone meetings where the participants speak his native or different languages are possible.

The particular combinations of elements and features in the above detailed embodiments are exemplary only; the interchanging and substitution of these embodiments with other embodiments disclosed herein are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1-19. (canceled)

20. A media gateway for managing a transmission of data from a first communication entity towards a second communication entity, the media gateway comprising:
a receiver for receiving a first language indicator indicating a language associated with the first communication entity; and
a processor for determining, upon the basis of the first language indicator and a second language indicator, whether to translate the data into a language indicated by the second language indicator, the second language indicator indicating a language associated with the second communication entity.

21. The media gateway according to claim 20, wherein the processor is configured to determine to translate the data into the language indicated by the second language indicator if the first language indicator differs from the second language indicator.

22. The media gateway according to claim 20, further comprising a forwarder configured to forward the data towards a language translation entity for translating the data into the language indicated by the second language indicator to obtain translated data, if the language indicated by the first language indicator differs from the language indicated by the second language indicator.

23. The media gateway according to claim 20, further comprising a language translation entity configured to translate the data into the language indicated by the second language indicator.

24. The media gateway according to claim 20, wherein the receiver is configured to receive a gateway protocol message comprising the first language indicator, and wherein the processor is configured to extract the first language indicator from the gateway protocol message.

25. The media gateway according to claim 24, wherein the gateway protocol message comprises a gateway control protocol message (GCP).

26. The media gateway according to claim 20, further comprising a forwarder configured to:
pass the data towards the second communication entity if the language indicated by the first language indicator corresponds to the language indicated by the second language indicator; or
transmit translated data towards the second communication entity, the translated data representing a translation of the data into the language indicated by the second language indicator.

27. The media gateway according to claim 20, configured to communicate with a network control entity for receiving the first or second language indicator.

28. The media gateway according to claim 27, wherein the network control entity comprises a mobile switching center or a transit switching center.

29. A network control entity for controlling communications of a communication entity, the network control entity comprising:
a receiver configured to receive a signaling message from the communication entity;
a processor configured to detect a language indicator in the signaling message, the language indicator indicating a language associated with the communication entity; and
a forwarder configured to forward the language indicator towards another network control entity.

30. The network control entity according to claim 29, wherein the processor is configured to extract the language indicator from the signaling message if the signaling message comprises the language indicator.

31. The network control entity according to claim 29, wherein the signaling message is a Location Update message from a Home Location Register.

32. The network control entity according to claim 29, wherein either:
the processor is configured to insert the language indicator into an address message and the forwarder is configured to forward the resulting address message towards the other network control entity; or
the processor is configured to insert the language indicator into a gateway control protocol (GCP) message, and the forwarder is configured to forward the resulting GCP message towards the other network control entity.

33. The network control entity according to claim 32, wherein the address message is an Initial Address Message (IAM), and wherein the other network control entity is either a transit switching center or a media gateway.

34. The network control entity according to claim 29, wherein the network control entity is a mobile switching center and wherein the signaling message is a Radio Access Network Application Part (RANAP) message.

35. The network control entity according to claim 29, configured to communicate with another network entity, wherein:
the receiver is configured to receive the signaling message from the other network entity;
the processor is configured to extract the language indicator from the signaling message; and
the forwarder is configured to forward the language indicator towards a media gateway.

36. The network control entity according to claim 35, wherein the another network entity is a mobile switching entity.

37. A mobile station, comprising:
a processor configured to insert a language indicator indicating a language associated with the mobile station into a signaling message; and
a transmitter for transmitting the signaling message towards a mobile switching center to set up a communication link.

38. The mobile station according to claim 37, wherein the signaling message is a Radio Access Network Application Part (RANAP) message.

39. A multimedia resource function entity, comprising:
a receiver for receiving data for translation, and for receiving a language indicator indicating the language into which to translate the data;
a translation entity for translating the data into the language indicated by the language indicator to obtain translated data; and
a forwarder for forwarding the translated data towards a communication network.

40. A method for managing a transmission of data from a first communication entity towards a second communication entity, the method comprising:
receiving a first language indicator indicating a language associated with the first communication entity; and
determining, upon the basis of the first language indicator and a second language indicator, whether to translate the data into a language indicated by the second language indicator, the second language indicator indicating a language associated with the second communication entity.

41. A method for controlling communications of a communication entity, the method comprising:
receiving a signaling message from the communication entity;
detecting a language indicator in the signaling message, the language indicator indicating a language associated with the communication entity; and
forwarding the language indicator towards a network control entity.
